(19) United States
(12) Patent Application Publication
(10) Pub. No.: US 2006/0199166 A1
(43) Pub. Date: Sep. 7, 2006

(54) Child receiving device

(76) Inventors: Carol D. Snyder, East Aurora, NY (US); Christopher J. Hayes, West Falls, NY (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/069,042

(22) Filed: Mar. 2, 2005

(51) Int. Cl. G09B 25/00

(52) U.S. Cl. 434/365

(57) ABSTRACT

A child-receiving device including a child-receiving portion and an activity portion is disclosed. The child-receiving portion may receive a child in both the supine and seated positions. The activity portion may be reoriented from a first activity position for use by a child oriented in the supine position and a second activity position for use by a child oriented in the seated position. In addition, each of the child-receiving portion and the activity portion may include a receptacle configured to receive an entertainment element, wherein the entertainment element may be selectively repositioned from the child-receiving portion receptacle to the activity portion receptacle, and vice versa. The child-receiving device may further be configured to rock on a supporting surface.

### FIELD OF THE INVENTION

The present invention relates to a child receiving device operable to receive a child in the supine and seated positions and, in particular, to an interactive device including a child-receiving portion and an activity portion, wherein the activity portion is reconfigurable from a child supine position to a child seated position, and wherein each of the child receiving portion and the activity portion includes a receptacle adapted to receive an removable entertainment element.

### BACKGROUND

Children develop by interacting with their surrounding environment. Sensory stimuli are a child's first sources of learning; consequently, exposing a child to sensory stimulation such as audio and visual stimulation aids in development. For example, seeing bright colors, bold patterns, and moving elements develops visual tracking skills. Listening to music and sounds stimulates auditory skills. Touching materials of varying texture enhances tactile sensing and motor skills. Each of these activities, moreover, encourages a child to use cognitive skills to differentiate among sights, sounds, and textures. In addition, these activities provide an interactive experience during which a child makes things happen, thus developing a child's understanding of cause and effect.

For these reasons, toys are often designed to provide neurological stimulation and motor skill development opportunities. For example, infant gyms are designed to enhance both visual and auditory skills by providing an infant the opportunity to use her senses while interacting with the gym. Infant gyms encourage an infant to move because an infant will naturally kick at, reach for, and bat at toys. This, in turn, develops motor skills and coordination. In addition, lights and music generated by toy contact not only provide sensory stimulation, but also provide an opportunity for the infant to experience cause and effect. Thus, an infant gym full of visual appeal, different textures, and busy activities can satisfy a lot of needs—from exercising, developing, and refining motor skills, to stimulating senses, to challenging cognitive skills and functioning. Consequently, it is desirable to create an infant gym that provides a variety of interactive, sensory-stimulating opportunities.

The present invention is directed generally to a child-receiving or interactive device including a child-receiving portion and an activity portion. The child-receiving portion may receive a child in both the supine and seated positions. The activity portion may be reoriented from a first activity position for use by a child oriented in the supine position to a second activity position for use by a child oriented in the seated position. In addition, each of the child-receiving portion and the activity portion may include a receptacle configured to receive an entertainment element, wherein the entertainment element may be repositioned from the child-receiving portion receptacle to the activity portion receptacle, and vice versa. The device may further be configured to rock on a supporting surface.

### SUMMARY

Generally, the embodiments of the present invention provide a child-receiving device and, more particularly, to an interactive device including a child-receiving portion and an activity portion repositionable from a supine to a seated position, wherein both portions include receptacles operable to receive an interchangeable entertainment element.

### BRIEF DESCRIPTION OF THE DRAWINGS

FIG. 1 illustrates a perspective view of a child-receiving device according to an embodiment of the present invention including a child-receiving portion and an activity portion.

FIG. 2 illustrates a bottom perspective view of the child-receiving portion in isolation, showing a curved bottom surface.

FIG. 3 illustrates an isolated perspective view of the activity portion of the child-receiving device of FIG. 1.

FIG. 4 illustrates a perspective view of the activity device of FIG. 1, showing the mating relationship between the activity portion and the child-receiving portion.

FIG. 5 illustrates an isolated perspective view of the support members of the child-receiving portion.

FIGS. 6A-6C illustrate internal perspective views of the support members of FIG. 5, showing the operation of the reorientation mechanism.

FIG. 7 illustrates a side perspective view of the device of FIG. 1, showing the reorientation of the activity portion from a first position to a second position.

FIGS. 8A and 8B illustrate perspective views of the device of FIG. 1, illustrating the first (supine) activity position and second activity (seated) positions of the activity portion, respectively.

FIG. 9 illustrates perspective views of the removable entertainment elements according to an embodiment of the invention.

FIG. 10 illustrates a perspective view of the device of FIG. 1, showing the insertion of the entertainment elements into receptacles located in both the activity and child-receiving portions.

FIG. 11 illustrates an electronic schematic for the device of FIG. 1 according to an embodiment of the present invention.

Like reference numerals have been used to identify like elements throughout this disclosure.

### DETAILED DESCRIPTION

In accordance with the present invention, an interactive device including a child-receiving portion and an activity portion is disclosed. The child-receiving portion may be configured to rock on a supporting surface. The activity portion may be oriented for use by a child in either a supine or a seated position. The child-receiving and activity portions, moreover, may include receptacles configured to selectively receive entertainment elements such that the entertainment elements may be positioned in either the activity portion or the entertainment portion, or both.

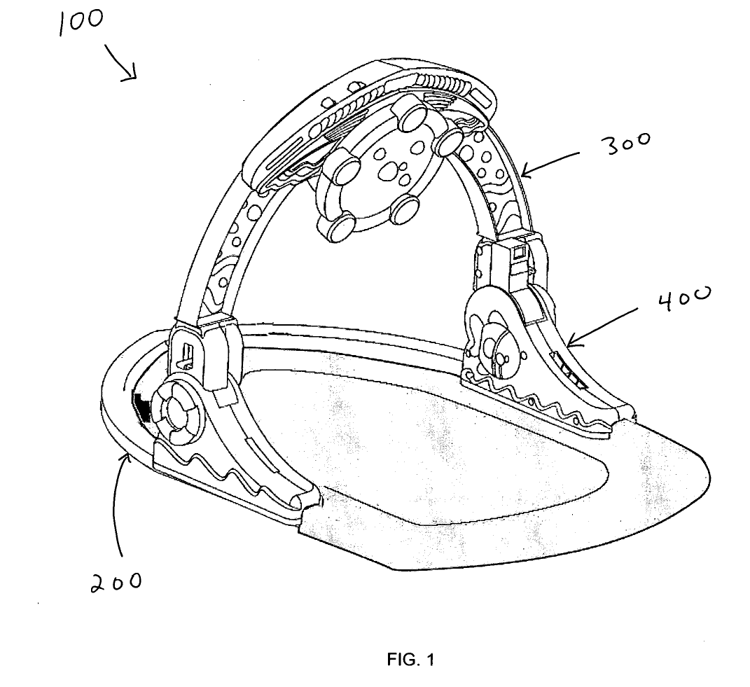

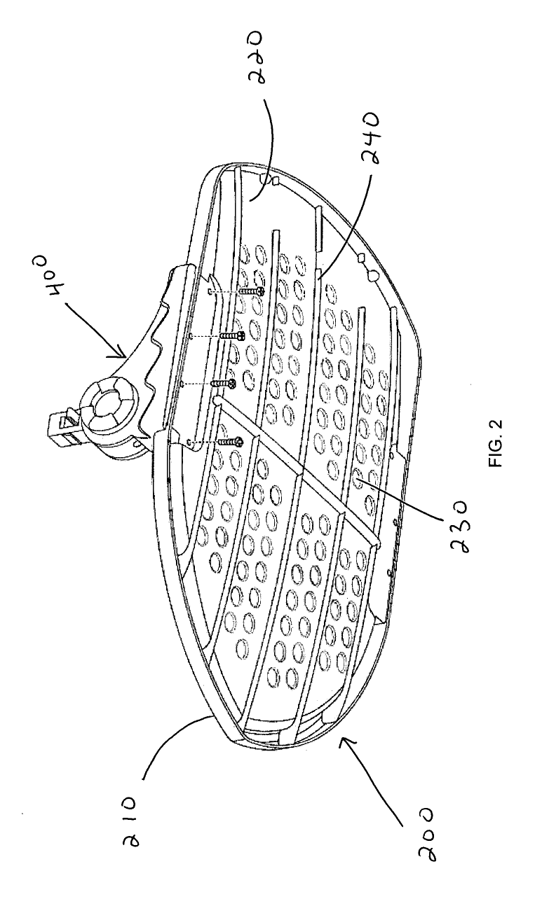

FIG. 1 illustrates a perspective view of a child-receiving device 100 according to an embodiment of the present invention. As shown, the device 100 may include a base or child-receiving portion 200 and an activity portion 300. The child-receiving portion 200 includes a structure configured to support a child oriented in a supine position and/or a seated position. The material comprising the child-receiving portion 200 includes, but is not limited to, rigid and/or lightweight materials such as plastic. FIG. 2 illustrates the child-receiving portion 200 of the device 100 according to an embodiment of the invention. The child receiving portion 200 includes a top surface 210 (where a child is positioned) and a bottom surface 220 (that contacts a supporting surface). The top surface may include a soft fabric mat positioned thereon (illustrated in FIG. 1).

The top surface 210 of the child-receiving portion 200 may further include a support section 400 (also shown in FIG. 1) to which the activity portion 300 connects. The support section 400 comprises a structure configured to support the activity portion 300 such that the activity portion 300 extends over the child-receiving portion 200. As shown in the embodiment of FIG. 1, the support section 400 may include a pair support members positioned along the left and right edges of the child-receiving portion 200 (the support members are discussed in greater detail below). The support members may be secured to the child-receiving portion 200 using conventional fasteners such as screws (as illustrated in FIG. 2).

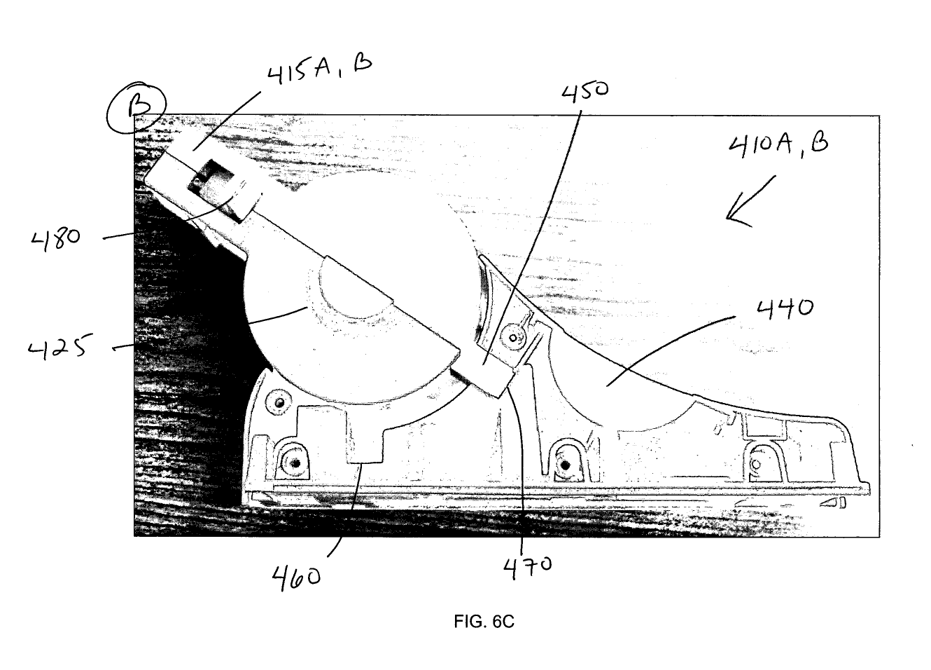

The bottom surface 220 of the child receiving portion 200 may be adapted to rock on a supporting surface. For example, the bottom surface 220 may be curved (i.e., as illustrated in FIGS. 2 and 7, the bottom surface 220 comprise a generally concave shape (a gradually curving surface)). Alternatively, the bottom surface 220 of the child-receiving portion 200 may include ridges 240 extending downward from the bottom surface 220 and running longitudinally along the child receiving portion 200. In addition, the bottom surface 220 of the child receiving portion may include rocker rails (not shown) extending downward from the bottom surface 220. With a curved surface, the child-receiving device 100 is capable of teetering or seesawing on a supporting surface in a generally longitudinal (front to back) direction. As such, the natural movements of a child lying in or sitting on the child receiving portion 200 can cause weight displacement or shift that, in turn, can generate a continuous or discontinuous rocking motion about the curved bottom surface 220.

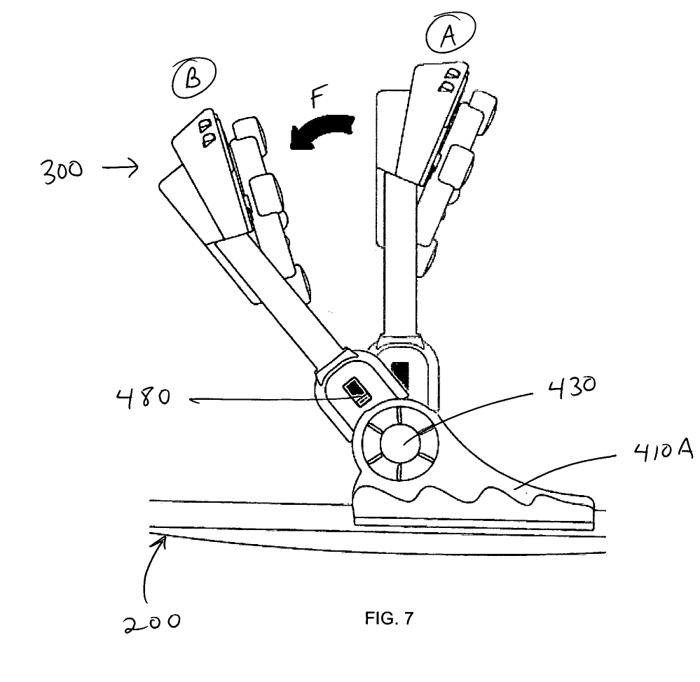

When configured to rock on a supporting surface, the child-receiving device 100 may further include a stabilizer member configured to immobilize the child-receiving device 100 and selectively prevent rocking motion. By way of specific example, the bottom surface of the child receiving portion 200 may include a structure similar to that of kickstand (illustrated as 805 in FIG. 8A), wherein the stabilizer member 805 rotates outward from bottom surface 220 and engages the supporting surface (as shown in FIG. 8A). As shown in FIG. 2, the child-receiving portion 200 may further include one or more apertures 230 to decrease the total weight of the child-receiving device 100.

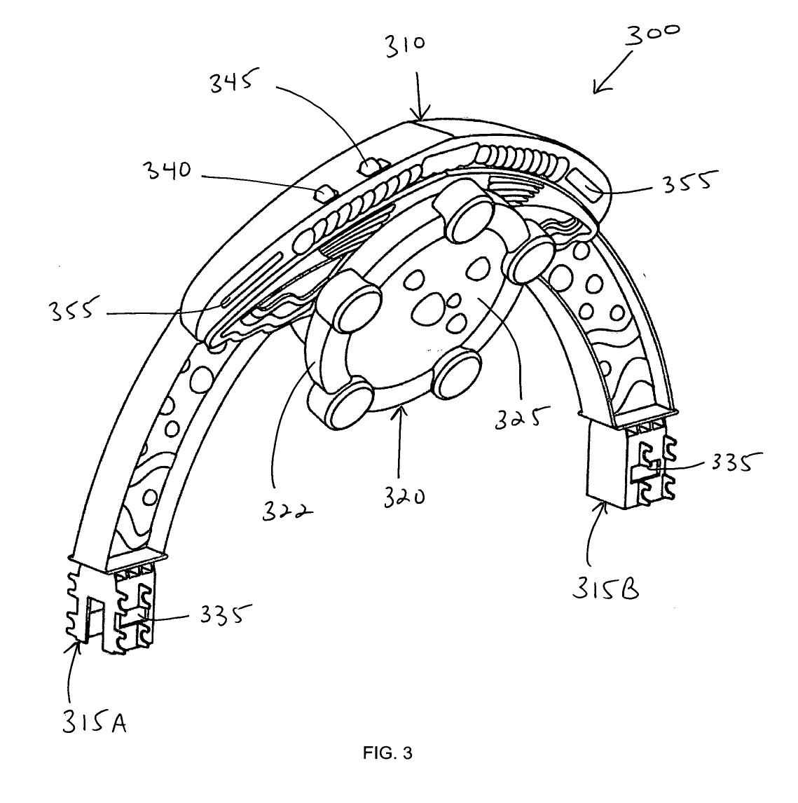

The activity portion 300 of the child-receiving device 100 may be configured to support at least one entertainment element, as well as house sensory generating (electronic) devices. FIG. 3 illustrates an isolated view of the activity portion 300 in accordance with an embodiment of the invention. As shown, the activity portion 300 may comprise an arch or bar having a central section 310, a left terminal end 315A, and a right terminal end 315B. The activity portion 300, however, is not limited to the embodiment illustrated in FIG. 3. The central portion 310 of the activity portion 300 may include one or more fixed entertainment or interactive elements 320 such as lights, animated members, and/or removable toys (discussed in greater detail below). By way of specific example, the fixed entertainment element 320 may comprise a housing 322 (stylized as a steering wheel) rotatably coupled to the central section 310 of the activity portion 300. The housing 322 may be selectively rotated by a motor contained within the activity portion 300.

The material comprising the housing 322 is not limited, and may include rigid, pliable, transparent, translucent, and/or opaque materials. Furthermore, the housing 322 may contain a fluid housed therein. The fluid may comprise, but is not limited to, gels, transparent fluid (e.g., water, glycerin, propylene glycol, combinations thereof, etc.), translucent fluid, and opaque fluid. The fluid, moreover, may be colored using conventional pigments and dyes. In the embodiment illustrated in FIG. 3, the housing 322 includes a transparent portion 325 through which the fluid may be viewed. In addition, the housing 322 may further include at least one decorative element suspended in the fluid (not shown). The decorative element may be tethered to the interior surface of the housing 322, or may be may float freely in the fluid contained in the housing 322. The decorative element may include, but is not limited to, figures (e.g., animals such as fish) and particles (e.g., glitter, holographic particles, foam pieces, confetti, etc). With this configuration, a child may interact with the entertainment housing 322. For example, when the material comprising transparent portion 325 is pliant, a child may interact with the transparent portion 322 by contacting the pliant transparent portion 325 and displacing fluid and/or the entertainment elements contained therein. In addition, the child may rock the child-receiving device 100 on the supporting surface to agitate the fluid and/or the entertainment elements contained therein. Also, when the motor that drives the rotation of the housing 322 is engaged, the rotation of the housing 322 may further agitate the fluid and/or the entertainment elements contained therein.

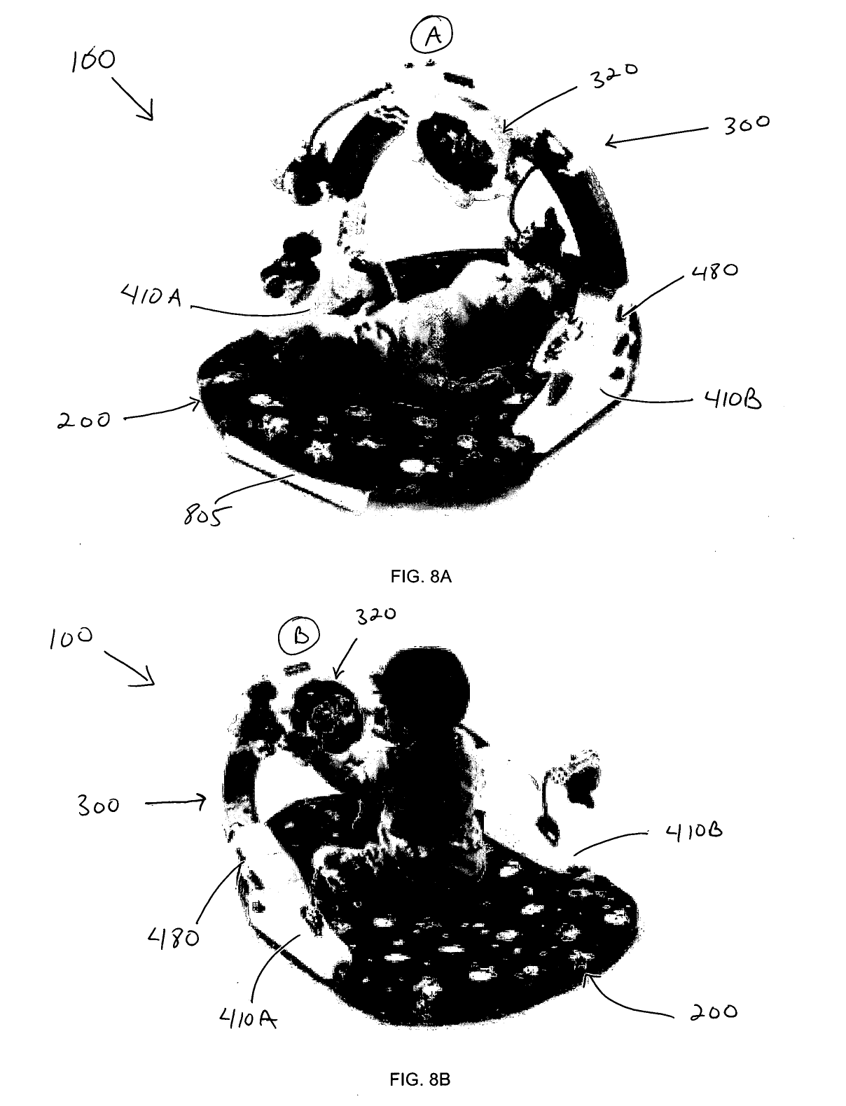

The activity portion 300 of the child-receiving device 100 may further include sensory generating devices such as speakers, light sources, motors, etc. (as discussed in greater detail below). The activity portion 300 of the child-receiving device 100, furthermore, may include one or more actuators operably coupled to a control unit (not shown in FIG. 3, but illustrated schematically in FIG. 9) and configured to control sensory stimulating output. The type of actuator is not limited, and may include depressible actuators, sliding actuators, etc. In the embodiment illustrated in FIG. 3, the activity portion 300 includes two actuators 340, 345. Each actuator 340, 345 may be coupled to a switch capable of sending a signal to a control unit (discussed in greater detail below). By way of example, actuator 340 may comprise a multi-positional, sliding actuator configured to engage a switch adapted to provide power to an electronics assembly (not shown), as well as to alter the output of the electronics assembly (e.g., adjust the volume of the output generated by a speaker). Similarly, actuator 345 may include a depressible actuator configured to engage a switch that generates or terminates output from the electronics assembly. The activity portion 300 of the child-receiving device 100 may further include an internal, motion-sensitive switch (not shown) activated when the child-receiving device 100 is rocked on a supporting surface. When the motion switch is engaged, sensory stimulating output (e.g., lights, sound, animation, etc.) may be generated.

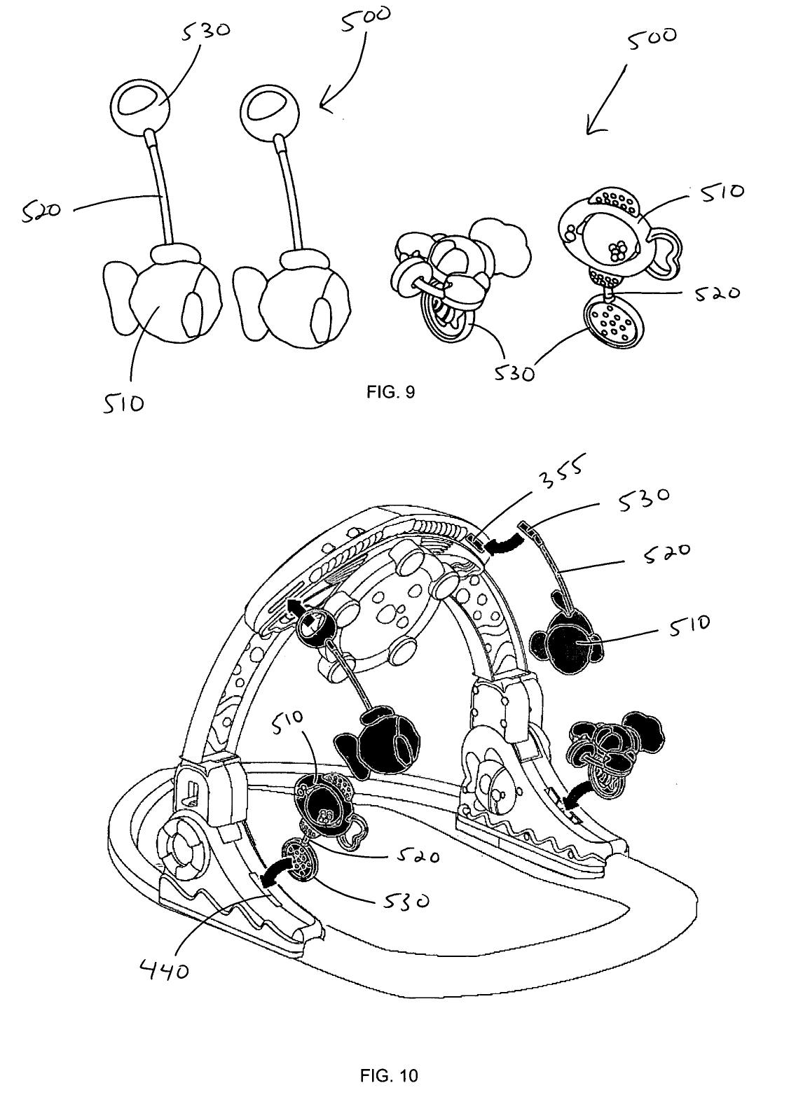

As shown in FIG. 3, the activity portion 300 of the child-receiving device 100 may further include one or more slots or receptacles 355 configured to receive a removable entertainment element (not shown, seen best in FIGS. 9 and 10). The shape of the receptacles 355 is not limited, so long as the shape corresponds and complements the shape of the engagement member of the removable entertainment element. In the embodiment of FIG. 3, each receptacle 355 comprises semi-circular cavity that at least partially receives an engagement member having generally circular disk shape (shown in FIGS. 9 and 10 and discussed in greater detail below).

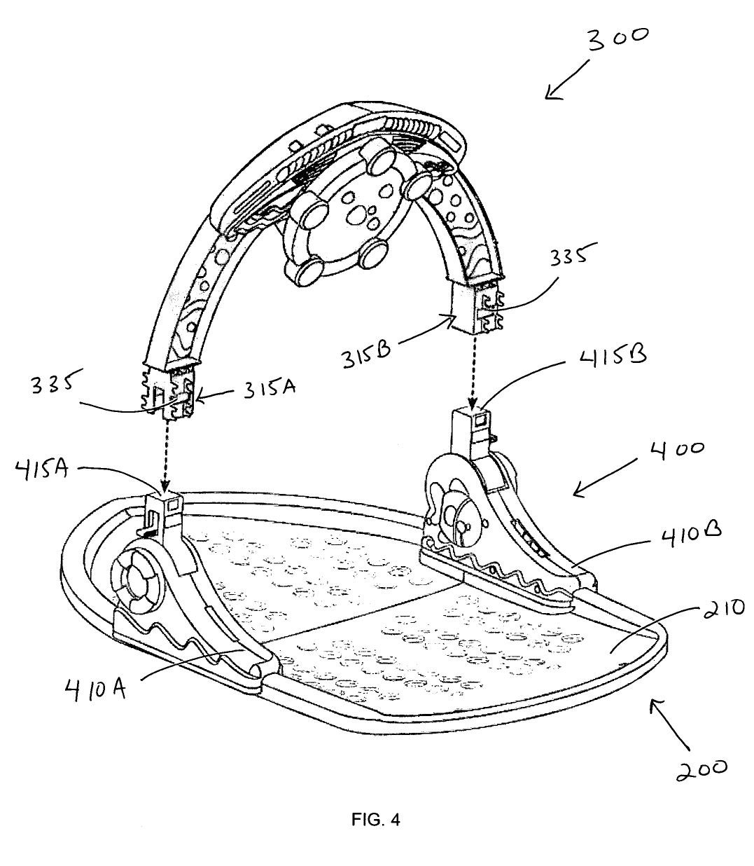

As discussed above, the activity portion 300 of the child-receiving device 100 may be connected to the child-receiving portion 200 through a support section 400. FIG. 4 illustrates the mating engagement of the activity portion 300 to the child-receiving portion 200 via the support section 400. As shown, the support section 400 includes a left support member 410A and a right support member 410B. Each support member 410A, 410B may include a post 415A, 415B configured to engage (be received by) a cavity within the appropriate terminal end 315A, 315B of the activity portion 300. As a result, the activity portion 300 may be connected to the support members 410A, 410B of the child-receiving portion 200 by aligning the cavities of the activity portion terminal ends 315A, 315B with its corresponding support member post 415A, 415B, and axially inserting the post 415A, 415B into the cavity. The activity portion 300 may be further secured to the posts 415A, 415B of the support members 410A, 410B using conventional fasteners including, but not limited to, screws.

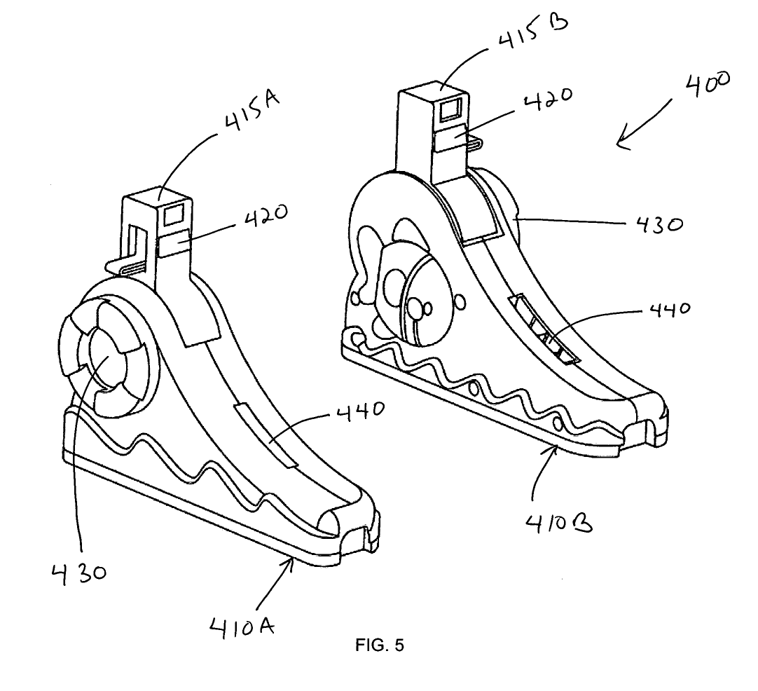

In addition, the activity portion 300 may be detachably secured to the posts 415A, 415B. FIG. 5 illustrates an isolated view of left 410A and right 410B support members in accordance with the present invention. Each post 415A, 415B of the support members 410A, 410B may include a spring-biased tab 420 extending radially outward from the post 415A, 415B. Each activity portion terminal end 315A, 315B, moreover, may include a window 335 (seen in FIGS. 3 and 4) configured to receive the tabs 420. As the terminal ends 315A, 315B of the activity portion 300 are axially inserted over the posts 415A, 415B, the tabs 420 of the support members 410A, 410B are depressed, permitting the posts to slide along the cavity of the terminal ends 315A, 315B. Once the tabs 420 become aligned with the widows 335, the force of the spring pushes the tabs 420 through the windows 335, preventing further movement of the terminal ends 315A, 315B and securing the activity portion 300 to the support section 400. To separate the activity portion 300 from the child-receiving portion 200, the process is reversed—the tabs 420 are depressed, permitting to axial movement of the posts 415A, 415B out of the activity portion terminal end cavities.

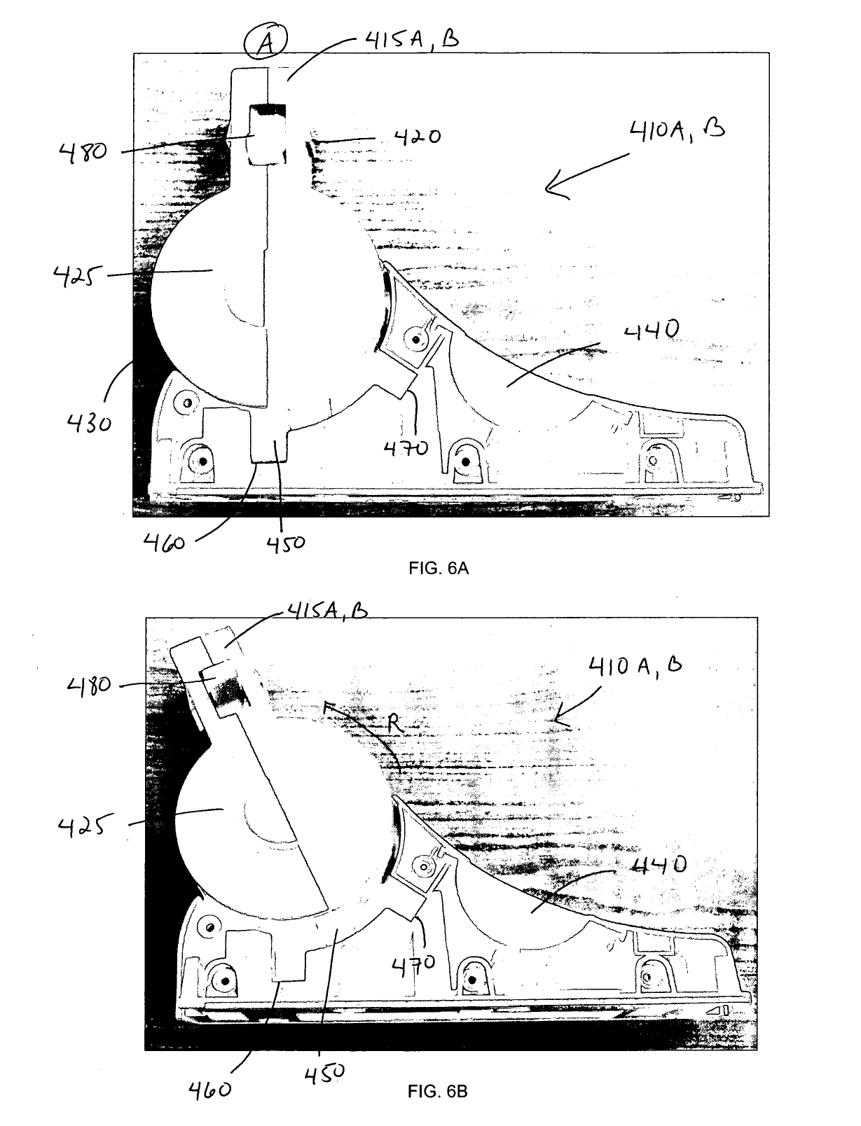

The child-receiving portion 200 may further include one or more receptacles 440 configured to receive a removable entertainment element (not shown). Specifically, as best seen in FIG. 5, receptacles 440 may be located within each of the support members 410A, 410B. The shape of the receptacle is not limited, so long as the shape corresponds and complements the shape of the engagement member on the removable entertainment element (not shown, discussed in greater detail below). By way of specific example, when the engagement member comprises a generally circular disk, the receptacles 440 may include a semi-circular cavity configured to at least partially receive the disk (as shown in FIGS. 6A and 6B, discussed below).

Each support member 410A, 410B may further include a reorientation mechanism 430 operable to move the activity portion 300 between a first activity position (position A) for use by a child oriented in the supine position and a second activity position (position B) for use by a child oriented in the seated position. Specifically, the posts 415A, 415B may be rotationally attached to the support members 410A, 410B so that they are moveable between a position at which each post 415A, 415B is substantially vertical with respect to the child-receiving portion 200 (position A) to a position at which each post 415A, 415B is rotationally offset from the vertical position (position B).

FIGS. 6A-6C illustrate the operation of the reorientation mechanism 430. Referring to FIG. 6A, the posts 415A, 415B include a base 425 pivotally mounted to the support member 410A, 410B. A retractable boss 450 may be biased downward or outward from the bottom of the base 425 by a spring (not shown). The support members 410A, 410B may include a first, vertically-oriented, slot 460 and a second, non-vertically-oriented, slot 470. The first slot 460 and the second slot 470 may be configured to slidably receive the retractable boss 450. In operation, when the boss 450 is positioned within the first slot 460 (as shown in FIG. 6A), the boss 450 is forced into the slot 460 by the downward bias caused by the spring (not shown), securing the posts 415A, 415B in a first activity (vertical) position (indicated as A in FIG. 6A). To move the posts 415A, 415B from the first activity position to a second activity position, a lever 480 located along the posts 415A, 415B may be provided that retracts the boss 450 into the base 425 and removes it from the first slot 460. Referring to FIG. 6B, since the base 425 is pivotally mounted to the support member 410A, 410B, and with the boss 450 retracted toward the base 425, a rotational force R may be applied to rotate the post 415A, 415B counterclockwise, driving the boss 450 toward the second slot 470.

Referring to FIG. 6C, the base 425 may be rotated until the boss 450 aligns with the second slot 470. Once aligned, the downward bias caused by the spring urges the boss 450 into the second slot 470. The second slot 470 secures the post 415A, 415B in the second (offset) activity position (indicated as B in FIG. 6C). To reorient the post 415A, 415B back to the first activity position A, the process is reversed. Briefly, the lever 480 is engaged to retract the boss 450 and permit the clockwise rotation of the base 425 until the boss 450 aligns with the first slot 460 (and the post 415A, 415B arrives back at position A).

In this manner, the reorientation mechanism 430 may be adapted to reorient the activity portion 300 from a first activity position A to a second activity position B. FIGS. 7, 8A, and 8B illustrate the operation of the repositionable activity portion 300, showing supine A and seated configurations B. Referring to FIG. 7, by engaging the lever 480 located on the support member 410A, 410B (to retract the boss 450) and applying a force F in the direction indicated by the arrow, the activity portion 300 may be moved from the first activity position (i.e., position A, indicated by ghost/dashed lines) to the second activity position (i.e., position B, indicated by solid/darkened lines). To move the activity portion 300 from the second activity position B to the first activity position A, the lever 480 is engaged and a reverse force is applied to the activity portion 300.

In the first activity position A (illustrated in FIG. 8A), a child set within the child-receiving portion 200 such that the child lies on her back (i.e., the child is in the supine position) is capable of interacting with the activity portion 300 by, e.g., batting at, kicking at, and/or contacting the entertainment elements (e.g., the removable entertainment elements or the fixed entertainment element 320), or by rocking the device 100 on the supporting surface. Similarly, in the second activity position B (illustrated in FIG. 8B), a child set within the child-receiving portion 200 such that the child is seated is also capable of interacting with the activity portion 300 by, e.g., batting at, kicking at, and/or contacting the removable entertainment elements or the fixed entertainment element 320, as well as by rocking the device 100 on the supporting surface.

As discussed above, the child-receiving device 100 of the present invention may include a removable entertainment element. FIG. 9 illustrates entertainment elements 500 in accordance with an embodiment of the present invention. The entertainment elements 500 may include an interactive toy 510, an extension element 520, and an engagement member 530. The toy 510 may comprise, but is not limited to, hard and soft material figures attractive to a child. Such figures may be stylized as an animal (fish, crustaceans, farm animals, zoo animals, domestic animals, etc.), cartoon characters, comic book characters, etc. In addition, the toy may be stylized as geometric shapes, numbers, letters, vehicles, buildings, etc. The extension element 520 may connect the toy 510 to the engagement member 530, as well as position the toy 510 in closer proximity to the child received in the child-receiving portion 200 (to encourage interaction).

The engagement member 530 may be adapted to be selectively received by each of the activity portion receptacles 355 and the support member receptacles 440. The size and shape of the engagement member 530 is not limited, so long as the engagement member 530 is capable of being securely and removably received by the receptacles 355, 440. As shown in FIG. 9, the engagement member 530 may comprise a disc-shaped element. Referring to FIG. 10, to connect an entertainment element 500 to the child-receiving portion 200 or the activity portion 300, the engagement member 530 is aligned with the receptacle 355, 440. Once aligned, the engagement member 530 may be axially inserted into the receptacle 335, 440 (also shown in FIGS. 8A and 8B). In addition, since all of the receptacles 355, 440 and the engagement members 530 are similar in size and shape; consequently, the entertainment elements 500 are selectively interchangeable. That is, an engagement member 530 originally placed in a support member receptacle 440 may be removed from the support member receptacle 440 and placed within an activity portion receptacle 355, and vice versa (e.g., the lobster of FIG. 10 may be placed in the activity portion receptacle 355).

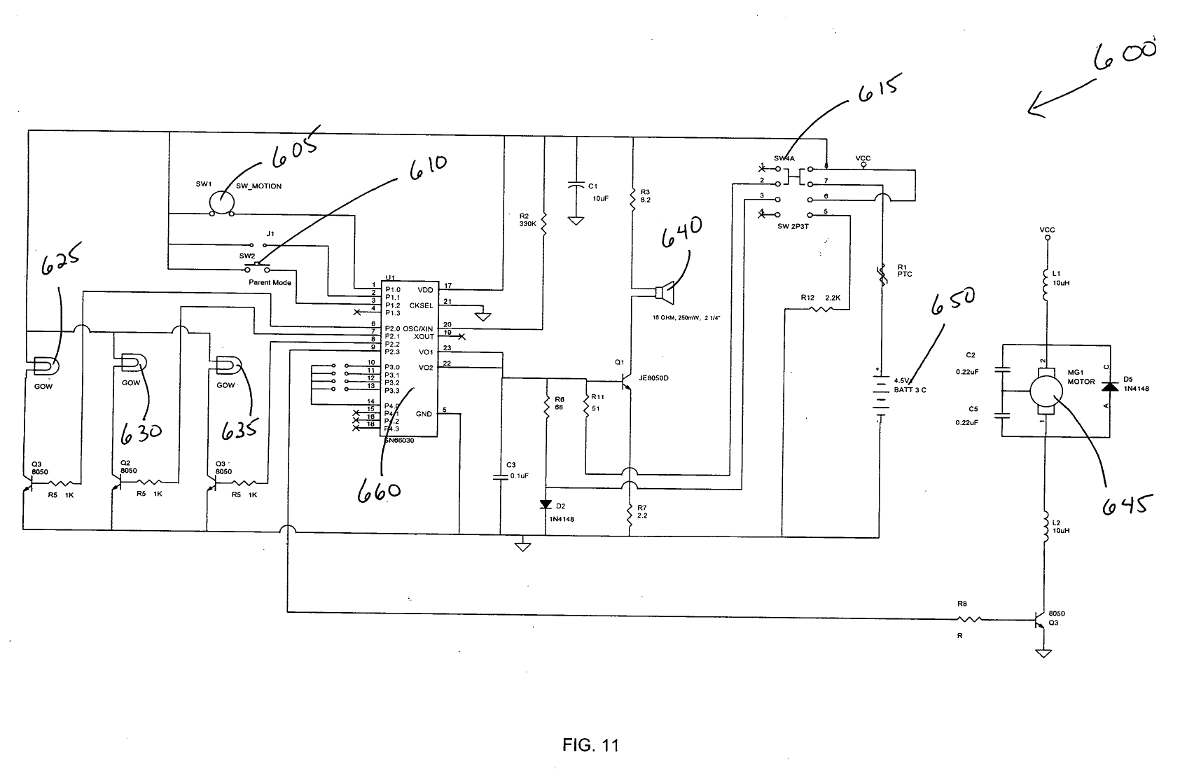

As discussed above, the child-receiving device 100 may include an electronics unit or assembly comprising one or more sensory stimulating and/or electronic components. FIG. 11 illustrates an electronic schematic for the child-receiving device 100 of FIG. 1 according to an embodiment of the present invention. In the illustrated embodiment, the electronics assembly 600 (contained within the activity portion 300) includes three switches 605, 610, 615; three light sources 625, 630, 635; a speaker 640, a motor 645, a power source 650, and a control unit 660. Each switch may comprise, but is not limited to, a motion switch, a mechanical switch (pressure sensitive, contact, push, pivot, and slide), an electrical switch, a magnetic switch, an optical switch, etc. The number of switches, moreover, is not limited.

Each switch may be associated with a particular electronic or interactive feature. For instance, a first switch 605 (SW1) may comprise a motion-sensitive switch operable to indicate when the child-receiving device 100 has been rocked forward, backward, or both. The type of motion switch is not limited. A second switch 610 (SW2) may be used to indicate whether the actuator 340 (see FIG. 3) on the activity portion 300 has been engaged. Similarly, a third switch 615 (SW4A) may be used to indicate whether the sliding actuator 345 (see FIG. 3) located on the activity portion 300 has been engaged. The third switch 615 may further include sub-switches to indicate the position of the actuator (e.g., each sub-switch may designate a desired volume level (e.g., high or low) depending on the position of the sliding actuator 345).

The light sources 625, 630, 635 may be positioned within the device 100 to illuminate desired sections. The type of light source may include, but is not limited to, light emitting diodes (LEDs) and/or grain of wheat (GOW) bulbs. The motor 645 may be configured to drive the entertainment housing 322 located on the activity portion 300 (i.e., when activated, the motor may rotate the fluid-filled steering wheel). The speaker 640 may include a 2.25 inch, 16 ohm, 250 mW speaker. The power source 650 may comprise, but is not limited to, alternating and/or direct current sources. By way of specific example, three “C” batteries may be used.

Each of the switches 605, 610, 615; the lights 625, 630, 635; the speaker 640, the motor 645, and the power source 650 may be operatively connected to the control unit 660. The control unit 660 is capable of producing switch-specific sensory stimulating electronic output such as animation, light, and sounds (verbal, music, sound effects, etc). The type of control unit 660 includes, but is not limited to, microcontrollers, microprocessors, and other integrated circuits. By way of specific example, the control unit may comprise a single chip, four channel voice synthesizer integrated circuit (available from SONiX Technology Company, Chupei City, Hsinchu, Taiwan (www.sonix.com.tw)). The control unit 660 recognizes and controls signals generated by the various switches 605, 610, 615, as well as generates and controls operational output directed through various sensory generating devices. For example, the control unit 660 may activate the lights 625, 630, 635; the speaker 640; and the motor 645 to generate electronic sensory stimulating output. The control unit 660 continually monitors the electronic status of the various switches and devices, generating and altering the sensory output accordingly.

The sensory stimulating output generated by the child-receiving device 100 is not particularly limited. Output may include audio (e.g., sound effects and music) and visual (e.g., motion and lights) output. By way of specific example, the electronics assembly/unit 600 may play short musical scores such as “Row Row Row Your Boat”, “Hukilau”, “Sailing, Sailing”, a Calypso tune, and “Down by the Bay”. In addition, it may play sound effects such as a musical riff from an instrument (e.g., a harp), a splash sound effect, a bubble sound effect, and a horn sound effect. Moreover, the particular play pattern is not limited to that disclosed herein. By way of example, when the motion-sensitive switch 605 is engaged (by rocking the child-receiving device 100), the motor 645 may be activated to drive the entertainment housing 322. In addition, lights may flash in time to music. Each activation may include one or more sound effects and musical scores. Each subsequent activation may generate another set of sounds and music. Once all the sound effects and music have been played, the play pattern may repeat.

The above-describe child-receiving device 100 provides an interactive infant gym that encourages development of a child. A child may interact with the child-receiving device 100 in a variety of ways, including but not limited to, rocking the child-receiving device 100 on a supporting surface (via the child's movements) to agitate the fluid within the entertainment housing 322, rocking the child-receiving device 100 to initiate sensory stimulating output, contacting the toys 500, etc. Each interaction engages the child's senses, and encourages motor skill and neurological development.

While the invention has been described in detail and with reference to specific embodiments thereof, it will be apparent to one skilled in the art that various changes and modifications can be made therein without departing from the spirit and scope thereof. For example, it is to be understood that terms such as “top”, “bottom”, “front”, “rear”, “side”, “height”, “length”, “width”, “upper”, “lower”, “interior”, “exterior”, “inner”, “outer” and the like as may be used herein, merely describe points of reference and do not limit the present invention to any particular orientation or configuration. The child-receiving device 100 may comprise any suitable materials and comprise any size and shape. The shape of the child-receiving portion 200 is not limited to that disclosed herein. For example, the child-receiving portion 200 may be shaped as a boat or other vehicle (cars, trucks, planes, etc). The child receiving portion 200 may be configured to rock on a supporting surfaced in a longitudinal (front to back) or latitudinal (side to side) direction. The size and shape of the activity portion 300 is not limited to that disclosed herein, and may include and number of interactive features, including but not limited to buttons, rattles, squeakers, hanging toys, removable toys, etc.

The electronics assembly/unit 600 may include any combination of lights, speakers, animated members, motors, and sensory output generating devices. The control unit 600 may produce any combination of audio and visual effects including, but not limited to, animation, lights, and sound (music, speech and sound effects). The output pattern is not limited to that disclosed herein and includes any pattern of music, lights, and/or sound effects. The electronics assembly 600 may also include additional switches to provide additional sensory output activation. Thus, it is intended that the present invention covers the modifications and variations of this invention that come within the scope of the appended claims and their equivalents.

We claim:

1. A child-receiving device comprising:
a child-receiving portion operable to receive a child positioned in a supine position and a seated position, the child-receiving portion operable to rock on a supporting surface; and
an activity portion extending across said child-receiving portion, said activity portion including at least one entertainment element attached thereto, the activity portion moveable between a first activity position for use by a child oriented in the supine position and a second activity position for use by a child oriented in the seated position.

2. The child-receiving device of claim 1, wherein said child-receiving portion comprises a curved base to enable the rocking of said device on said supporting surface.

3. The child-receiving device of claim 2, wherein said rocking of said device on said supporting surface is generated by weight displacement caused by movement of a child positioned within said child-receiving portion.

4. The child-receiving device of claim 1, wherein said activity portion comprises a toy bar.

5. The child-receiving device of claim 4, wherein said toy bar is rotationally attached to said child-receiving device.

6. The child-receiving device of claim 5, wherein said toy bar is operable to rotate from said first activity position to said second activity position.

7. The child-receiving device of claim 1, wherein said activity portion further includes an electronics unit adapted to generate sensory output.

8. The child-receiving device of claim 7, wherein a rocking motion of said device activates said electronics unit.

9. The child-receiving device of claim 1, wherein said device further includes a stabilizer member configured to immobilize said child-receiving portion and selectively prevent rocking motion.

10. The child-receiving device of claim 1, wherein said child-receiving portion includes at least one receptacle configured to receive said entertainment element and wherein said activity portion includes at least one receptacle configured to receive said entertainment element, said entertainment element operable to be repositioned from said at least one activity portion receptacle to said at least one child-receiving portion receptacle.

11. The child-receiving device of claim 10, wherein said entertainment element comprises an engagement member adapted to be selectively received by said at least one activity portion receptacle and said at least one child-receiving portion receptacle.

12. The child-receiving device of claim 11, wherein said entertainment element engagement member comprises a disc-shaped element, and wherein each of said at least one activity portion receptacle and said at least one child-receiving portion receptacle comprises a slot adapted to selectively receive said entertainment element engagement member.

13. The child-receiving device of claim 1, wherein said entertainment element comprises a housing including a transparent portion and a fluid housed therein, wherein said fluid is viewable through said transparent portion.

14. The child-receiving device of claim 13, wherein said housing is rotatably coupled to said activity portion, and wherein rotation of said housing agitates said fluid.

15. A child-receiving device comprising:
a child-receiving portion operable to receive a child positioned in a supine position and a seated position, said child-receiving portion including at least one receptacle configured to receive an entertainment element;
an activity portion extending across said child-receiving portion, said activity portion including at least one receptacle configured to receive an entertainment element; and
an entertainment element selectively repositionable from said at least one child-receiving portion receptacle to said at least one activity portion receptacle.

16. The child-receiving device of claim 15, wherein said entertainment element comprises an engagement member adapted to be selectively received by said at least one activity portion receptacle and said at least one child-receiving portion receptacle.

17. The child-receiving device of claim 15, wherein said entertainment element engagement member comprises a disc-shaped element, and wherein each of said at least one activity portion receptacle and said at least one child-receiving portion receptacle comprises a slot adapted to selectively receive said entertainment element engagement member.

18. The child-receiving device of claim 15, wherein said child-receiving device is operable to rock on a supporting surface.

19. The child-receiving device of claim 18, wherein said rocking of said device on said supporting surface is generated by weight displacement caused by movement of a child positioned within said child-receiving portion.

20. The child-receiving device of claim 18, wherein said activity portion further includes an electronics unit adapted to generate sensory output, and wherein said electronics unit is activated by said rocking of said device on said supporting surface.

21. The child-receiving device of claim 18, wherein said child-receiving portion further includes a stabilizer member configured to immobilize said child-receiving portion and selectively prevent rocking motion.

22. The child-receiving device of claim 18, wherein said child-receiving portion includes a curved base to enable the rocking of said device on a supporting surface.

23. The child-receiving device of claim 15, wherein said activity portion comprises a toy bar.

24. The child-receiving device of claim 15, wherein said activity portion is rotationally attached to said child-receiving device.

25. The child-receiving device of claim 24, wherein said activity portion is operable to rotate between a first activity position for use by a child oriented in the supine position and a second activity position for use by a child oriented in the seated position.

26. The child-receiving device of claim 15, wherein said activity portion further includes a housing at least partially filled with fluid, and wherein said housing includes a transparent portion through which said fluid may be viewed.

27. The child-receiving device of claim 26, wherein said housing is rotatably coupled to said activity portion, and wherein rotation of said housing agitates said fluid.

28. The child-receiving device of claim 26, wherein said child-receiving device is capable of rocking motion, and wherein said rocking motion agitates said fluid.

29. The child-receiving device of claim 15, wherein said activity portion further includes an electronics unit adapted to generate sensory output.
